(19) United States
(12) Patent Application Publication
(10) Pub. No.: US 2012/0322682 A1
(43) Pub. Date: Dec. 20, 2012

(54) BRAIN INJURY BIOMARKER PANEL

(75) Inventors: John MCDEVITT, Houston, TX (US); Nicolaos CHRISTODOULIDES, Houston, TX (US); Pierre N. FLORIANO, Houston, TX (US)

(73) Assignee: WILLIAM MARSH RICE UNIVERSITY, Houston, TX (US)

(21) Appl. No.: 13/526,519

(22) Filed: Jun. 19, 2012

Related U.S. Application Data
(60) Provisional application No. 61/498,761, filed on Jun. 20, 2011.

(51) Int. Cl. C40B 40/10; C40B 30/04

(52) U.S. Cl. 506/9; 506/18

(57) ABSTRACT

A panel of biomarkers for diagnosis, monitoring of progression and prognosis of various brain injuries and PTSD.

### PRIOR RELATED APPLICATIONS

This application claims priority to 61/498,761, filed Jun. 20, 2011, and incorporated herein by reference in its entirety.

### FEDERALLY SPONSORED RESEARCH STATEMENT

Not applicable.

### FIELD OF THE INVENTION

Herein described is a powerful integrated panel of biomarkers that can be used for the laboratory or on-site screening, diagnosis, monitoring and prognosis of brain injuries, such as traumatic brain injury (TBI) and the associated problem of Post Traumatic Stress Disorder (PTSD).

### BACKGROUND OF THE INVENTION

A brain injury is any injury occurring in the brain of a living organism. Brain injuries can be classified along several dimensions. Primary and secondary brain injury are ways to classify the injury processes that occur in brain injury, while focal and diffuse brain injury are ways to classify the extent or location of injury in the brain. Specific forms of brain injury include:
Brain damage, the destruction or degeneration of brain cells.
Traumatic brain injury, damage that occurs when an outside force traumatically injures the brain.
Stroke, a vascular event causing damage in the brain.
Acquired brain injury, damage to the brain that occurs after birth, regardless of whether it is traumatic or nontraumatic, or whether due to an outside or internal cause.

Traumatic brain injury (TBI), also known as intracranial injury, occurs when an external force traumatically injures the brain. Brain trauma can be caused by a direct impact or by acceleration alone. Common causes include falls, vehicle accidents, and violence. In addition to the damage caused at the moment of injury, a variety of events take place post-injury to cause secondary injuries. These processes, which include alterations in cerebral blood flow and pressure changes within the skull, contribute substantially to the initial damage from the injury.

TBI can be classified based on severity, mechanism (closed or penetrating head injury), or other features (e.g., occurring in a specific location or over a widespread area). Head injury usually refers to TBI, but is a broader category because it can involve damage to structures other than the brain, such as the scalp and skull.

TBI is a major cause of death and disability worldwide, especially in children and young adults. There are approximately 1.5 to 2 million annual incidents in the United States, especially among young adults. Of these, about 50,000 patients die and 500,000 are hospitalized. Of the mild TBI injuries, 40-50% of patients suffer persistent neurological problems from one to three months following injury, and 25% still have problems after one year. This represents more than 500,000 new cases of injury-related disability each year.

TBI can cause a host of physical, cognitive, social, emotional, and behavioral effects, and outcome can range from complete recovery to permanent disability or death. The 20th century saw critical developments in diagnosis and treatment that decreased death rates and improved outcome. These include imaging techniques, such as computed tomography and magnetic resonance imaging. Depending on the injury, treatment required may be minimal or may include interventions, such as medications and emergency surgery. Physical therapy, speech therapy, recreation therapy, and occupational therapy may be employed for rehabilitation.

Post-traumatic stress disorder (PTSD) is another type of brain damage, caused by a psychological, rather than a physical, trauma, although it is often comorbid with TBI in military engagements, natural disasters and severe accidents. PTSD is a severe anxiety disorder that can develop after exposure to any event that results in psychological trauma. This event may involve the threat of death to oneself or to someone else, or to one's own or someone else's physical, sexual, or psychological integrity, overwhelming the individual's ability to cope. As an effect of psychological trauma, PTSD is less frequent and more enduring than the more commonly seen acute stress response. Diagnostic symptoms for PTSD include re-experiencing the original trauma(s) through flashbacks or nightmares, avoidance of stimuli associated with the trauma, and increased arousal—such as difficulty falling or staying asleep, anger, and hypervigilance. Formal diagnostic criteria (both DSM-IV-TR and ICD-10) require that the symptoms last more than one month and cause significant impairment in social, occupational, or other important areas of functioning.

Many symptoms of brain injury mirror the symptoms of PTSD. Individuals suffering from either injury typically experience one or more of the following: memory loss, difficulty concentrating, shortened attention spans, slower thinking processes, irritability, difficulty sleeping, depression, and impulse control problems. With so many shared symptoms, it is difficult to diagnose the patients injury.

All types of brain injuries are difficult to accurately diagnose. Diagnosis of TBI is suspected based on lesion circumstances and clinical evidence, most prominently a neurological examination, for example checking whether the pupils constrict normally in response to light and assigning a Glasgow Coma Score. Neuroimaging helps in determining the diagnosis and prognosis and in deciding what treatments to give. However, CT and MRI scans require expensive machinery, and are typically not available at point of care situations, e.g., in a military engagement.

PTSD is typically diagnosed based on psychological evaluation, although there are reproduceable changes in various serum markers. For example, most people with PTSD also show a low secretion of cortisol and high secretion of catecholamines in urine, with a norepinephrine/cortisol ratio consequently higher than comparable non-diagnosed individuals. Brain catecholamine levels are high, and corticotropin-releasing factor (CRF) concentrations are high, suggesting abnormality in the hypothalamic-pituitary-adrenal (HPA) axis. As with the above imaging methods, such laboratory tests are frequently not available at point of care situations, e.g., in a military engagement or other emergency situations.

Although there are currently no biomarkers with proven clinical utility for diagnosis of brain injury, whether it is caused by TBI, stroke, or other acute brain injuries, research has uncovered several candidates that have shown some preclinical potential. The markers currently generating the most interest include lactate dehydrogenase (LDH), glial fibrillary acid protein (GFAP), neuron specific enolase (NSE), and 5-100β. Although these proteins are currently being assessed, they appear to lack either the necessary sensitivity or brain specificity (or both) to be used effectively alone.

More recently a number of new candidate biomarkers have been discovered. The emerging data suggest UCH-L1, MAP-2, and TAU proteins, and the alpha II-spectrin protein breakdown products (SBDPs) have strong possibilities. Currently Banyan Biomarkers, Inc. is performing assay validation of MAP-2 and UCH-L1 sandwich ELISA assays. Clinical validation with human serum samples using these biomarkers is in progress.

Usually, the levels of potential biomarker proteins increase following injury and are found in increasing concentrations in the CSF depending on the injury magnitude. Eventually they find their way into the blood stream via a compromised blood brain barrier. How quickly the biomarkers are cleared from the bloodstream is a major factor in determining its final measurable concentration in the blood. When neuroproteomic studies yield a multitude of potential biomarkers, there are several key factors involved in selection or triage of a particular biomarker.

These criteria include preliminary data (literature relevance and proprietary nature of the biomarker), biomarker protein attributes (i.e., molecular weight, proteolytic cleavage, tissue specificity, stability), and cross-species sequence similarity (i.e., human, rat, mouse). Finally, there are two major criteria that need to be critically assessed to determine whether the biomarker is a good candidate: 1) whether it is detectable in the blood stream in quantifiable amounts that are indicative of the underlying pathological condition and 2) its specificity to the brain injury.

A biomarker's success also depends on the development of a sensitive and reliable platform that is easily used. Today's most commonly used assay is one that is Enzyme-Linked ImmunoSorbent Assay (ELISA)-based. The most critical component of a biomarker platform will be its ability to measure TBI severity, as early as possible following injury. That ability, developed and validated in a platform, begins with the capability to develop an assay that can detect the biomarker proteins at extremely low concentrations. To date, the most common validation technology relies on antibodies to ensure accuracy and precision of data. Due to the advances in immunological methods, a wide range of antibody-based diagnostic tools have now been authenticated.

The ultimate objective, following the successful development of an assay kit, is to translate this into a user friendly, portable or handheld point-of-care device capable of monitoring a panel of markers in the body fluids, such as blood, saliva or urine with minimally invasive or non-invasive procedures. Presently, no point-of-care tests capable of detecting biomarkers for brain trauma in human biofluids are commercially available, but a number of companies have been drawn to the need and are working on such devices. Such a device would be very useful for doctors and EMTs in the civilian population, as well as for the military medics in warzones to assess the existence and severity of head trauma. A major challenge however, is that these potential biomarkers exist at extremely low levels, often at or beyond the detection capabilities of conventional ELISA technology. This ultimate challenge may necessitate the use of advanced technology devices, such as nanotechnology to increase their detection sensitivity as well as their specificity.

Thus, what is needed in the art are reliable methods of obtaining biological samples and testing same for markers that indicate brain injuries, such as traumatic brain injury or PTSD. This panel of biomarkers could be used/tested for at a variety of diagnostics settings, such as in the clinical laboratory or point of care/need environments, such as at trauma centers or front line medical facilities.

### SUMMARY OF THE INVENTION

The invention is a panel of biomarkers related to TBI and PTSD diagnosis. Using any known or future assay platform, a technician can measure a plurality of biomarkers, including but not limited to:

3-methoxy-4-hydroxyphenylglycol (MHPG)
4-hydroxynonenal
Alpha II Spectrin Breakdown Products (SBDPs)
Allopregnanolone
C-Reactive Protein (CRP)
Catecholamines
Cortisol
Dehydroepiandrosterone (DHEA)
Dehydroepiandrosterone-sulfate (DHEA-S)
F2-isoprostane
Fatty acid binding proteins (FABPs) Brain (B)-FABP and Heart
(H)-FABP
GABA
Glial fibrillary acid protein (GFAP)
Interleukin-1 (IL1)
Lactate dehydrogenase (LDH)
Macrophage inflammatory protein (MIP)
Microtubule-associated protein (MAP-2)
Monocyte chemo-attractant protein-1 (MCP-1)
Myelin basic protein (MBP)
N-acetylaspartate (NAA)
Neopterin
Neuron specific enolase (NSE)
Norepinephrine (NE) or norepinephrine/cortisol ratio
Neuropeptide Y (NPY)
p11 an annexin II subunit, an auxiliary protein associated with the
background K⁺ channel, TASK-1
IL6
S100 calcium binding protein B (S100b)
Amyloid A
IL8
IL2
TAU proteins
Testosterone
Thyroid hormone
Transforming growth factor-beta (TGF-β or TGFB)
Tumor necrosis factor (TNF-alpha or TGFA)
Ubiquitin C-terminal hydrolase (UCH-L1)
Dopamine

Preferably, more than one biomarker is tested at the same time, as both multiplexing and parallel processing reduces the overall time and reagents needed for dignostics, but it is also possible to test a panel of biomarkers sequentially. At least three of the above biomarkers should be assessed, and preferably, 4, 5, 6, 7, 8, 10, 12, 15 or more, although the optimal panel combination will require several more years of effort to validate. Preferably, two to four markers can be tested in a multiplex fashion, in a platform that allows addressable identification of analyte-specific sensors or if detection agents/tracers differentiated via analyte specific color fluors, and/or an array of markers can be tested. For example, if each bead in an array is conjugated to two separate capture antibodies, then two biomarkers can be captured at each bead, and e.g., detected with separate detection antibodies—one green and the other red-labelled. In this way, an array of 10 beads can robustly detect 20 separate biomarkers.

The tests can be performed with either laboratory-confined diagnostic technologies, such as clinical analyzers, or Enzyme Linked ImmunoSorbent assay (ELISA) kits, but more preferably with a portable point-of-care device, such as those described in WO2007002480, WO2007053186, WO2005090983, WO2005085855, WO2005083423, WO2005085854, WO2005085796, WO2004009840, each incorporated herein by reference. Other examples of such devices are set forth in Goodey et al., J. Amer. Chem. Soc., 123(11):2559-2570, 2001, and Christodoulides et al., Lab. Chip, 5(3):261-9, 2005, the entire contents of which are incorporated by reference into this application.

The device itself should have a small footprint, and preferably uses disposable microfluidics, such as are commonly found on lab-on-chip devices. In such embodiments, the tests demonstrate ultra low limits of detection (≦10 ng/ml, preferably ≦1 ng/ml) and wide assay ranges that, in some cases, span up to four or five orders of magnitude of marker concentration. To our knowledge there is no competitive technology available in this area.

Many point-of-care diagnostic devices are under development or in commercial use and may also be suitable for the application of the test, provided the devices have sufficient sensitivity and reliability. For example, RaidDx by Sandia, the Claros by Claros Dignostics, Agilent™ 2100 bioanalyser; LabChip® EZ Reader; VereID™ Biosystem; Micro Total Analysis System (μTAS); Analyzer™, are already available. However, we envision that a dedicated device will be manufactured to be specific for this application, thus minimizing the size and complexity of the device, while maximizing ease of use.

Another embodiment of the invention is a disposable chip or lab card containing reagents specific for detecting the above listed brain biomarkers. Thus, a chip can contain an array of antibodies for the various biomarkers, or the antibodies can be processed together if each has a different detection method, such as a different secondary antibody coupled with a different color fluorescent reagent.

Another embodiment of the invention is a disposable chip or lab card containing reagents specific for detecting the above listed brain biomarkers. Thus, a chip can contain an array of bead sensors coupled to capture antibodies and on-spot matched detection antibodies for the capture/detection of various biomarkers in “sandwich”-type immunoassays.

In other embodiments, the invention is a cartridge comprising a substrate having inlets and microfluidics for moving fluid and a plurality of individual sensors arrayed thereon.

Preferably, each sensor is a porous polymeric bead or flat pad having a brain biomarker antibody bound thereto (either covalently bound or just adsorbed, adsorbed, or adhered thereto). Most preferred are crosslinked agarose based beads or pads.

However, antibodies can be arrayed in any fashion now known or to be developed, including ink jet printing of arrays, membrane based arrays, glass slide based arrays, and the like. Several companies already make arrays for commercial use, including the 3-D polymer based glass substrates (FULL MOON BIOSYSTEMS™, Sunnyvale Calif.), Panorama® Antibody Array (SIGMA-ALDRITCH®, St. Louis Mo.), Proteome Profiler™ arrays (R&D Systems, Minneapolis Minn.), slide based PathScan® Antibody Array Kits (CELL SIGNALING TECHNOLOGY™, Beverly Mass.), and many more.

The cartridge or card can also include chambers with dried reagents therein, as well as chambers or blisters containing fluids for use in said system. The card can include wash buffers, reaction buffers, dried detection antbodies, and the like. For example, labelled detection antibodies can be applied to an absorbent pad, dried and placed into an openable chamber. When activated, fluid from a blister passes through the pad chamber, reconstituting the dried detection antibodies coupled to a signaling reagent (for example a fluorophore) where a sandwich type assay is used. The labeled detection antibodies pass to the array chamber, and bind to their targets leaving a detectable signal on washing.

In such cases, the analyzer can include mechanical actuators that apply pressure for the bursting of the blisters in a controlled fashion for the delivery of the said buffers and reagents according to a preloaded program parameters.

The signaling reagent can be any reagent capable of providing a signal to the optical or energy sensing means, and preferably are fluorescent dyes, radioactive reagents, phosphorescent, chemi-luminescent or other energy emitting reagents. Particularly preferred dyes include Alexa Fluor® dyes ranging from 350 to 790 (blue through infrared) nm absorption maxima.

In other embodiments, the invention is the cartridge as described above, which can also include internal microfluidics on said substrate for carrying fluid to and from said bead sensors, as well as sample and/or fluid entry/exit ports port(s), together with a valve or access port, e.g., a pinch valve or elastomeric stopper for accessing said internal microfluidics. Alternatively, the micofluidic card can have a slot for insertion of one of the commercially available array platforms, such as the glass slide arrays.

The invention also include brain injury diagnostic methods, using the cartridge and device of the invention. Preferably, a sample is provided by using a finger prick blood sample, which is then inserted in the lab card/analyzer for drug measurement. Alternatively, the same method may be used in conjunction with serum, spinal fluid, saliva, urine or other biological fluid. The sample is applied to the cartridge, which is then inserted into the slot on the analyzer, fluids are applied, signal is generated and the data is read and displayed either on the device or an independent display means.

In another embodiment, the invention is a diagnostic system for brain injury testing comprising an analyzer or reader having a housing containing a slot for receiving a cartridge, a brain biomarker testing cartridge (as described above), a processor having a user interface, an optical or energy sensing means, and a means for moving fluid. In a preferred embodiment, the housing also contains heating and cooling means, such a piezoelectric heater/cooler, radiant heater and fan, peltier, and the like. The optical sensing means is configured to receive a signal from said brain biomarkers, and the microfluidics are configured so as to allow fluid movement past said brain biomarkers. The processor and user interface controls the system and the processor records data from said optical sensing means. Also preferred is device that includes a display means operably connected to said processor for displaying said data, but the display means is optional, and a data-port can instead connect to independent processors and/or display means.

In preferred embodiments, the assays are protein and antibody based, and one or more antibodies are conjugated to fluorescent labels, but any target and detection method can be used. Thus, any “target-detector binding pairs” can be used, including but not limited to DNA-DNA, DNA-RNA, glycoprotein-leptin, enzyme-substrate, matched capture/detection antibody pair, receptor-ligand, and other target detection pairs can be employed, as well as any labels or detection methods, many of which are known in the art.

In some embodiments, the sample tested is body fluids collected via non-invasive ways, such as saliva, urine or minimally-invasive (needle prick) whole blood or other readily available fluid, but various samples can be used in the method of the current invention. Examples include, but are not limited to, tears, nipple aspirate, serum, blood, cerebrospinal fluid, saliva or other oral fluid specimen, urine and biopsy samples, and the like.

In particular, the invention include a minimally-invasive, pain-free assessment/classification of brain injury using e.g., blood, which, when used in conjunction with a point-of-care device, introduces the possibility of a test that can be deployed in military- or emergency-situations. This enables more rapid and effective assessment of the condition and, hence, improved outcomes due to earlier treatment and the resulting reduction of health care costs. The method can also be used to gauge the efficacy of treatment and guide future interventions or therapy.

Preferably, the brain biomarker testing cartridge has positive and negative control bead sensors and calibrator bead sensors, and every brain biomarker bead sensor is present in said array in at least duplicate, 3×, 4× or more.

Preferably, each bead sensor is a porous polymeric bead of size between 50-300 nm, and a size variation of ±10% or ±5% or less, and having at least one capture reagent conjugated thereto. Usually, the capture reagent is conjugated to said bead sensor via a linker, but this can vary depending on the bead sensor and capture reagent chemistry. Preferably, the bead sensor comprises crosslinked agarose, and the linker is a peptide or protein, such as BSA.

Abbreviations

| | |
|---|---|
| % CV | % coefficient of variation |
| Ab | Antibody |
| ABS | Acrylonitrile butadiene styrene |
| BM | Biomarker |
| BSA | Bovine serum albumin |
| cAOI | circular area of interest |
| CP | circular profile |
| CTL | Control |
| DNA | Deoxyribonucleic acid |
| DSA | double sided adhesive |
| fAOI | fixed AOI |
| ICS | Immunochromatographic strip |
| ID | integrated density |
| LOC | Lab on chip |
| LOD | Limit of Detection |
| LOQ | Limit of Quantitation |
| LP | Line profile |
| MAb | Monoclonal antibody |
| PBS | Phosphate buffered saline |
| RNA | Ribonucleic acid |
| SI | signal intensity |
| SS | stainless steel |
| SSA | single sided adhesive |

As used herein, “embedded” channel or chamber, what is meant is that the channel or chamber is enclosed inside the substrate, rather than being an open top channel or chamber on the surface of the substrate. Embedded channels and chambers can be made in lab cards, as described in US20040132059, US20050233440 and U.S. Pat. No. 7,635,454, or can be made by welding layers together, at least one of which has a surface channel therein.

By “reader” or “detector” or “analyzer” what is meant is a device that contains the optics, optic sensing means, processor, user interface, and fluidics and is the device that runs the assays described herein and thus “analyzes” the sample and “reads” or “detects” the results.

By “card” or “cartridge” or “chip” what is meant is a generally planar substrate having microfluidic channels and/or chambers therein, as well as one or more access ports, and houses an diagnostic array and/or reagents specific for the testing assays described herein.

By “label” or “tracer” what is meant is any detectable chemical, but preferably including a bioluminescent, chemi-luminescent or fluorescent molecule.

By the term “array” what is meant is an adressable location, such that the user knows which biomarker (or biomarkers) is detected in a given location. Arrays are traditionally rectangular arrays, e.g. 4×5 spots, but this is not essential.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention, such as instructions for use, special packaging, preservatives, antioxidants, and the like. For example, the antibodies are considered material, but wash buffers are not, and thus PBS can be replaced with any suitable buffer in such a claim.

When a drug or chemical is referred to be name herein, all active salts, isomers, and derivatives thereof are considered to be included.

The word “obtaining” when used in a claim means both direct and indirect methods of obtaining a sample or biomarker level information. Thus, collecting sample or biomarker levels via third parties are included in the scope of the term.

All percentages are by volume, unless indicated otherwise.

The following description aims to provide more detailed description of the invention and to illustrate the general principles of the invention. It should not be taken in a limiting sense. The section titles and overall organization of this section are adopted for the convenience of description and are not intended to limit the present invention.

### DESCRIPTION OF THE DRAWINGS

FIG. 1 Bead image analysis methods: Line profile (LP), circular area of interest (cAOI), integrated density (ID), circular profile (CP) and fixed AOI, for the generation of dose response curves for a bead-based assay.

FIG. 2. Low end dose response titration curve for MCP-1. X axis is MCP-1 concentration in pg/mL, Y axis is Signal Intensity in absorbance units (AU).

FIG. 3. Dose response titration curve for MCP-1. Axes as in FIG. 2.

FIG. 4A-B shows a top plan view 4A of an exemplary cartridge, and a perspective view 4B showing details of a preferred access hatch construction.

### DESCRIPTION OF THE INVENTION

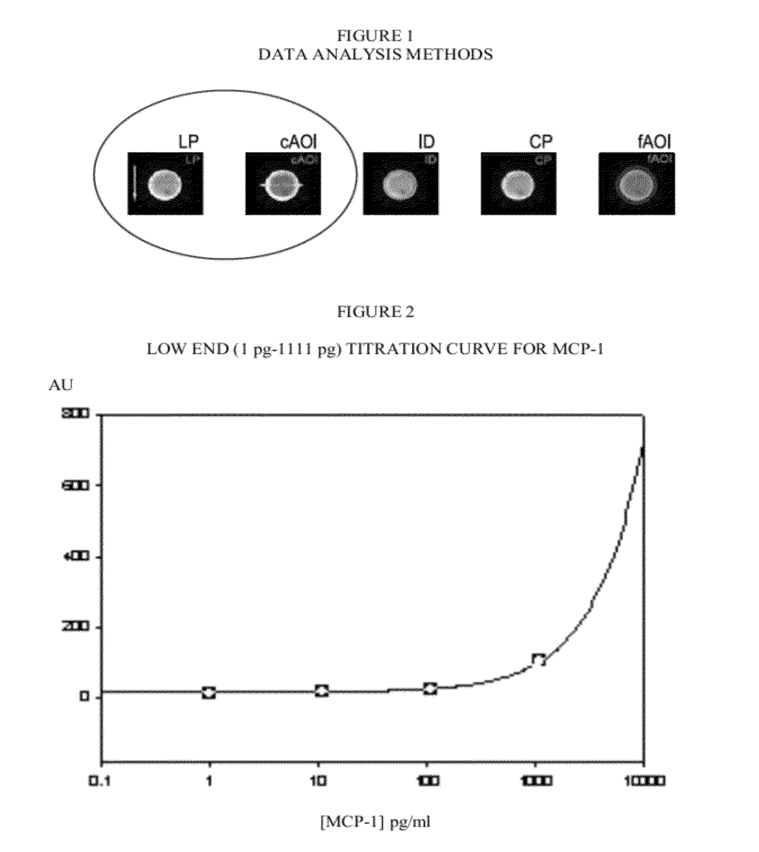

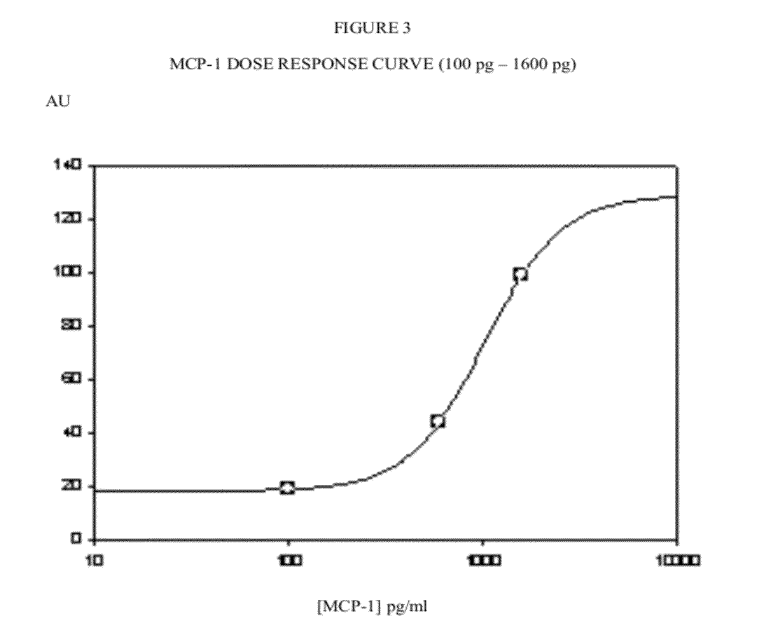

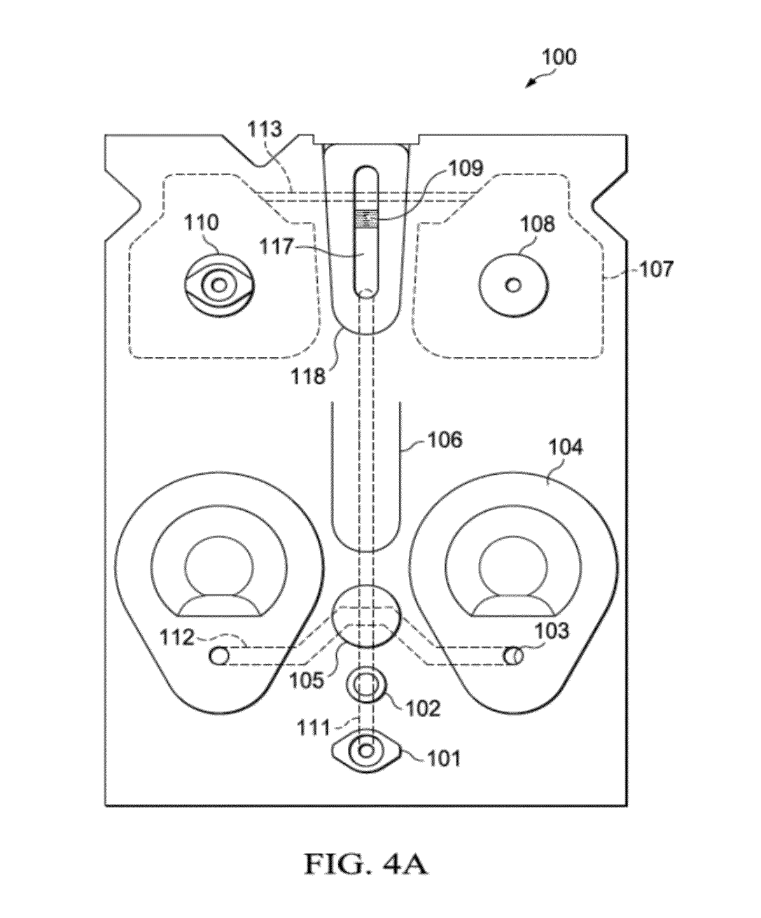

FIG. 1 Bead image analysis methods: Line profile (LP), circular area of interest (cAOI), integrated density (ID), circular profile (CP) and fixed AOI, for the generation of dose response curves for a bead-based assay. Each bead from the array was probed with these different data analysis strategies. Dose response curves generated by each method were compared and the method, or combination of methods, that provided the most sensitive and wide detection capabilities were selected as the optimal image analysis approach for subsequent experiments. Line profile and circular area of interest were the most informative data analysis method, and exemplary data is shown in FIGS. 2-3.

In proof of concept studies, we tested CRP, MCP-1 and IL6 in sandwich antibody assays. FIGS. 2 and 3 represent 2 dose responses acquired in one attempt to assay MCP-1, only at different exposures of the CCD. These two graphs may be combined to offer a really wide assay range. Using a macro-scale prototype device we were able to achieve picogram limits of detection (LOD) as well as a very wide assay range extending to more than 5 decades of concentrations, as derived from the combination of the 2 dose curves resulting from two different exposure settings of the CCD (camera) of the optical device.

Beads (280 +/−10 μm) were used in the proof of concept studies as easiest to make and handle. However, bead size will be reduced substantially in the final assay development; and it is anticipated that the bead size will be much less (50-100 μm). Beads were developed as described previously (Christodoulides, Ann. N.Y. Acad. Sciences 1098:411-428 (2007)).

Furthermore, beads are only one convenient way of creating an array. However, flat agarose pads can be used in place of spherical beads, or the antibodies can be ink jet printed directly to a suitable surface and bound thereto. For example, antibody arrays can be absorbed or conjugated to a porous substrate and fluid forced through the porous substrate. Alternatively, antibodies can be printed onto the bottom of a channel, and fluid flow over the antibody as it travels the channel. As another example, arrays can be printed onto glass slides. Any array technology known or hereinafter developed can be used to create the array.

Past research with bead sensors consistently revealed that the precision of the assays was highly dependent on their size homogeneity. Accordingly, an integral component of the bead production protocol included a sieving step where beads within a ±10 μm diameter distribution were selected. Thus, beads should be sorted to obtain a narrow size range, preferably ±10% or more preferred ±5% or less.

Some outlier beads do occasionally appear in the array. However, because of the bead redundancy associated with this approach (at least 3 beads dedicated for each bead type) in conjunction with the application of automated image analysis macros that can identify and, thus, exclude the outlier beads based on established outlier removal routines, such as median tests, Grubbs, or Dixon tests from the statistical analysis that are embedded in the data analysis modules, we can achieve assays with excellent intra- and inter-assay precision (typically at 5-10% CV and 3-10% CV, respectively). Preliminary evaluation of the precision of the tests we developed for this program showed intra-bead % CV between 2 -12%. We anticipate that the same methodology can be applied to other arrays, e.g., arrays that are printed onto substrates, since the spots will generally be round and also show edge effects.

We used 2%-6% cross-linked, glyoxylated agarose beads for the bead based assays. Agarose particles (6% crosslinked) used for the enzyme-based studies were purchased from XC PARTICLE CORP™ (Lowell, Mass.). The particles were glyoxal activated (20 moles of activation sites per milliliter) and were stored in sodium azide solution.

Capture antibodies were conjugated to the beads by known procedures (Goodey 2001).

Detection antibodies were labelled according to the manufacturer's directions using the Alexa-Fluor 488 from INVITROGEN®.

The assays were performed at room temperature under continuous fluid flow conditions using a prototype lab-on-chip system. In brief, the system uses a commercial card reader called ANALYZER™ and lab-assembled cartridges containing an array of bead sensors, with two reagent blisters containing buffer with microfluidic channels connecting same. The bead sensors were arrayed by placing the beads onto a bead holder with forceps (tweezer). The bead holder includes an array of wells, each of which hosts a single bead in addressable position within the array. The array is dropped into a slot or recess in the cartridge for same and the cartridge placed into the slot in the analyzer for same.

The total assay time is normally 10-12 minutes. This included the sequential priming of the microfluidic lines, delivery of the tracer/sample mixture to the array of bead sensors and a final wash with PBS.

After each assay run, photomicrographs of the bead array were captured at various charged coupled device (CCD) exposure settings (see Table). The ANALYZER™ instrument was equipped with various excitation filters, which can be selected as needed depending on which label is selected for detection, including red, blue and green signals.

The images were saved as 24-bit colorized TIFF files and analyzed via NIH ImageJ software (Bethesda, Md.) with bead fluorescence signal intensity correlating to the concentration of biomarker in the sample.

Customized macros were developed and optimized for the automated analysis of bead-based assays serve to determine the exact bead location, followed by their respective bead-specific assignments and to extract bead data using 5 different “regional pixel extraction-analysis” strategies that can be automatically applied for the generation of dose response curves as well as used for the measurement of the various biomarker levels in unknown samples.

The assays benefited from automated image and data analysis macros developed specifically for this application (FIG. 1). Five dedicated image analysis “probing” strategies are shown in FIG. 1, including Line profile (LP), circular area of interest (cAOI), integrated density (ID), circular profile (CP) and fixed AOI.

The algorithm compiled results for each bead, statistical analysis with exclusion of outliers within each group of beads and output log files with the average, standard deviation and coefficient of variance for each group that can be inserted and further processed into a Microsoft Excel environment. Intensity versus concentration calibration curves were constructed with best-fit regression analysis for determination of unknown sample concentration. Data obtained from the testing of standards and zero antigen controls were then entered and processed to derive the dose response curves, as well as assay characteristics, such as limit of detection, assay range and precision.

The dose response data, as well as data obtained from the testing of samples, were entered into unknown prediction equations according to standard curves obtained for each analyte on the system to determine the drug concentrations. Further enhancement in data quality was obtained by using image acquisition with various exposure times. The latter feature was developed with the flexibility that allows selective independent analysis for each assay using the optimal integration time for each target drug under the various conditions tested.

Line Profile (LP) and circular Area of Interest (cAOI) were the two image analysis methods that consistently provided the best results. Hence, these two methods were selected and used extensively for the validation of the drug tests with respect to assay performance studies.

For the Line Profile, a series of lines going through about 80% of the beads were profiled for the maximum intensities (or maxima). Because the signal is typically lower at the center of the beads, the product of a line profile is typically two maxima at the edge of the bead. All measurements were averaged and outliers identified and removed according to well established non-proprietary outlier removal routines (median, Grubb's, or Dixon tests).

For circular Area of Interest, a series of concentric areas centered on the center of the beads, and starting with a diameter of only a few pixels are drawn with increasing radii. For each of these circular areas, the average intensity per pixel was calculated and the circle was increased until it has exceeded the size of the bead by 10%. The maximum signal obtained typically at the bead periphery can be determined from the highest circular area value.

The LOD, LOQ, detection range and dynamic range (range of quantitative data) for each biomarker-specific assay were established as follows: The assay dilution buffer was processed in the absence of antigen to establish the mean signal intensity on the marker sensor beads for the zero-analyte condition (baseline) in response to the tracer. The standard deviation from bead to bead of the zero-analyte condition was recorded and used to derive a threshold signal intensity (SI) value using the signal intensity of the biomarker-sensitized beads minus 3× standard deviations for the “zero” marker condition. The assay was then repeated with increasing concentrations of biomarker standard antigen added in each run and signal intensities for the marker sensor beads within the array for each concentration were averaged and recorded.

The LOD for a competitive type of assay was defined as the lowest concentration of antigen standard that yields an average bead signal lower than the threshold SI value. The LOD for a non-competitive type of assay was defined as the lowest concentration of antigen standard that yields an average bead signal higher than the threshold SI value. The detection range of a competitive assay was defined by its LOD at the low end of analyte concentrations and by the protein standard concentration that caused the ultimate level of decrease in the signal. The detection range of a non-competitive assay was defined by its LOD at the low end of analyte concentrations and by the protein standard concentration that caused the ultimate level of increase in the signal. The mean signal intensity from the analyte-specific beads was then plotted against the analyte concentration to establish the dose-response curve for the given assay. The LOQ for competitive assays was determined as the lowest standard concentration on the linear portion of the dose-response curve (usually ˜10 SD below the SI from the zero condition); The LOQ for non-competitive assays was determined as the lowest standard concentration on the linear portion of the dose-response curve (usually ˜10 SD above the SI from the zero condition); the LOQ together with the lower end of the linear portion of the curve were used to establish the lower end of the quantitative range (also known as useful range or dynamic range) of the competitive assay. The LOQ together with the higher end of the linear portion of the curve were used to establish the higher end of the quantitative range (also known as useful range or dynamic range) of the competitive assay.

The reagents and assay conditions, as well as results were as follows:

TABLE 1
Sandwich immunoassay

| Antigen | Human CRP | Human MCP-1 | Human IL6 |
|---|---|---|---|
| | Fitzgerald-30-AC10 | Serotec-PHP061 | eBiosciences-14-8069 |
| | 100, 10, 1 ng/mL | 0.1 ng/mL-10 ng/mL | |
| Capture | anti-CRP MAb | anti-MCP-1 MAb | Mouse anti-IL6 MAb |
| antibody | Fitzgerald-10-C33A | Serotec-MCA2486: | R & D Systems-MAB206 |
| | 6 mg in 500 ul | 1.5 mg in 500 ul | 5 mg/ml in 500 ul |
| Detection | Anti-CRP MAb | Anti-MCP-1 MAb | Anti-IL6 MAb |
| Antibody | Fitzgerald-10-C33C | GeneTex - GTX18677 | Cell Sciences-CMI302 |
| | 1:500 dilution of | 1:500 dilution of | 0.5 mg/0.5 ml |
| | 6.1 mg/ml stock | 1 mg/ml stock | |
| Fluor | Alexa-Fluor 488 | Alexa-Fluor 488 | Alexa-Fluor 488 |
| | Invitrogen-A20181 | Invitrogen-A20181 | Invitrogen-A20181 |
| Blocking Step | No | No | No |
| Antigen capture | 30 min | 30 min | 30 min |
| PBS Wash | 5 min | 5 min | 5 min |
| Detection | 10 min | 10 min | 10 min |
| PBS wash | 5 min | 5 min | 5 min |
| Negative | TNF-alpha | ICAM-1 1 mg | ICAM-1 |
| control | | Serotec-MCA1615XZ | |
| Range | 1-100 ng/ml | 100 pg/ml-100 ng/ml | Not yet available, but |
| | | | predicted to be 3-4 |
| | | | orders of magnitude |
| LOD | 1 ng/mL | 100 pg/mL | Not yet available, but |
| | | | predicted to be less than |
| | | | ng/ml levels |
| % CV | <10 | <12 | <15 |

FIGS. 2 and 3 show exemplary data for MCP-1. The remaining data is only summarized herein in the interests of conserving space.

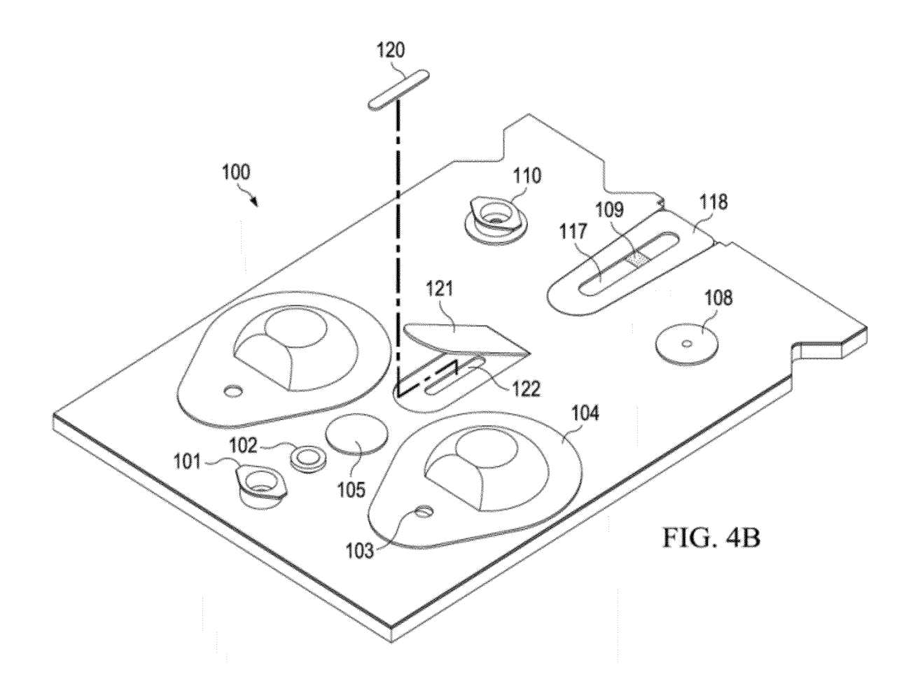

FIG. 4A and 4B shows an exemplary cartridge, which is disposable and fits into a standard reader. The details can vary, but this is one exemplary design for a lab card.

In more detail, 101 is the sample entry port, which is fluidly connected via microfluidics 111 to the bead support chip chamber 117 (also called an assay chamber). A small array of bead sensors (see black square 109) fits inside this chamber, which has a transparent lid 118. Pinch valve 102 functions to allow controlled delivery of microfluidic elements. Buffer entry ports 103 are fluidly connected 112 to microfluidic channel 111. One, two or more blister packs 104 can contain liquid reagents, such as wash buffers. Alternatively, the device could be connected directly to an external fluid source via buffer entry ports 103, but the blister packs are preferred as being more self-contained and providing a smaller footprint. The blisters are accessed via pressure actuation, a function provided by the analyzer/reader and embedded software, and thus are preferably foil blisters.

Bubble trap 105 allows for pressure relief, otherwise the fluid would not flow in the tiny channels. Alternatively, waste chambers 110 can be closed under negative pressure (vacuum) and thus pull fluid in their direction when one or more valves are opened.

Reagent port 106 can contain an absorbent pad 120 (see perspective inset 4B) having dried reagents (e.g., labeled antibody-tracer) thereon. Thus, reagent port 106 can consist of an access hatch or affixed cover 121 and recess 122, into which reagent pad 120 can be placed. Alternatively, reagent port 106 could be another blister pack or again just an inlet allowing connection to external fluids.

Waste reservoir 107 and waste reservoir external vent 108 are also fluidly connected via microfluidic channel 113 to assay chamber 117 having a transparent access hatch or affixed cover 118 allowing visual access to the bead array, but keeping the beads airtight. Optional port to waste chamber 110 is also shown, although the chamber can be made sufficiently large to hold all waste and this port omitted.

This particular card has only one assay chamber 117, but a series of assay chambers 117 can be processed in parallel, each having their own microfluidics and reagents and this will allow more parallel processessing of samples.

In preferred embodiments, a disposable plastic chip containing the microfluidics is made by injection molding and/or etching of parts and adhering layers together. Access hatch 121 (shown open) at recess 122 and access hatch 118 (shown closed) at recess 117 allow the insertion of the bead array 109 and reagent pad 120, and can then be closed and tightly sealed, e.g., with heat or adhesive. Blisters are added via adhesive strip.

Preferred materials for constructing the cartridge are plastics of durometer 34-40 Shore D for the substrate and microfluidics, such as polymers and copolymers of styrene, acrylic, carbonate, butadiene, propylene, vinyl, acrylonitrile, and foil for the blisters. However, chips can also be made with semiconductor materials by typical semiconductor etching and patterning methods and the like.

We envision that a detector will be designed and manufactured specifically for this assay, as this will allow simplification of the device and its software, and minimization of the footprint. Ideally, the device will be reduced to a hand held size, and thus be easy for staff to use in point-of-care testing environments. The analyzer (aka reader or detector) serves as a universal interface, providing the user with access to a fully embedded software, and components needed to run the assay, read the results, and convert the data to a user friendly output.

The analyzer is composed of i) a loading deck or insertion slot for the lab card, ii) optics, iii) charged coupled device (CCD camera) or other light or signal measuring means, iv) software, v) mechanical actuators for movement of microfluidics (e.g., needle for piercing blister packs and means for moving/actuating same), vi) pump, and vii) data output (e.g., paper and printer) and/or USB port and/or display means and viii) data input means. We have used a CCD camera herein, but plastic scintillation detectors may also prove useful and be cost effective.

In use, the user inputs the patients name and critrical data, collects and applies the sample to the card, loads the card into the analyzer, presses a start button, and the device runs the tests and outputs the answers, preferably together with a risk evaluation and/or suggested treatment options.

Competitive immunoassays using AGP-1 and UBQ were performed as another proof of concept study. The platform used was as described above. The test reagents and conditions were as follows:

TABLE 22
Competitive immunoassay

| | | |
|---|---|---|
| Antigen | Alpha-1 Acid Glycoprotein | Ubiquitin |
| | Sigma-Aldrich-G9885 | EMD Millipore-12-558 |
| | 5 MG 1:250 dilution | 1:250 dilution |
| | Labeled with tracer | Labeled with tracer |
| Capture | Anti-AGP-1 polyclonal Ab | Anti-Ubiquitin MAb |
| antibody | Cell Sciences-CSI20402A | Acris |
| | 3 mg/mL | Antibodies-AM12030PU-L |
| | | 3 mg/mL |
| Tracer | Alexa-Fluor 488 | Alexa-Fluor 488 |
| | Invitrogen-A20181 | Invitrogen-A20181 |

| | |
|---|---|
| Assay | 1 min. PBS prime at 47% |
| Conditions | 20 sec. antigen prime at 42% |
| | 15 min. antigen incubation at 7% |
| | AGP-1 and Ubiquitin cocktail at 100 ng/ml |
| | concentration each |
| | 2 min. PBS wash at 42% |
| | 20 sec. tracer prime at 42% |
| | 6 min tracer incubation at 7% |
| | 1:250 dilution per tracer (AGP-1 Ag + AF488 |
| | and Ubiquitin Ag + AF488) |
| | 4 min. PBS final wash at 42% |
| Range | Not yet available, but predicted to be 3-4 orders of magnitude |
| LOD | Not yet available, but predicted to be ng/ml levels |
| % CV | Not yet available, but predicted to be about 10% |

A field environment is likely to be quite different from a lab environment with trained technicians, complex machinery, and optimal working conditions. As one example, in the field, it is likely that the beads may be opened to air, and not used for some time. Therefore, methods of stabilizing the beads against drying out were undertaken and glycerol was tested as a preservative or anti-drying agent.

Initial experiments indicated that treatment with about 30% glycerol (in PBS) served as an effective method to maintain the moisture around the beads, while likewise maintaining the structural capacity of the beads. Furthermore, in experiments with other (non-brain) analytes, we confirmed that the glycerol stabilized beads were good for up to five days air exposure, and that the glycerol did not interfere with the immunoassay.

The lab-based assay must be further optimized for field use, especially as regards sample collection and test procedures. To that end we are testing a variety of field formats, including use of commercially available swab tests for sample collection and the use of a pin prick, capillary collection system for blood that can easily be combined with the lab card (e.g, a small pin can protrude from the card in the area of the sample inlet).

The tracer can also be applied in various ways. It can be added by the user to the sample buffer or be kept in dried form in a separate cap to be added to the sample buffer once the sample is washed in the buffer (if applicable). Alternatively, it can be contained in a reagent blister or in a dried reagent pad in the fluidic pathway. It is expected that this third alternative will be the most user friendly, however, all methods will be tested. Of course, the stability of dried reagent will have to be assessed, but dried antibodies are already extensively used in home testing kits and are known to be reliable and long lasting.

These proof of concept data demonstrate that a brain injury biomarker test can be developed and used in emergency care settings. The tests can be in sandwich format or competitive format, and employ with either mono- or polyclonal antibodies. The tests are very sensitive and accurate, yet quick and easy to perform even in this preliminary form. Further, in our laboratory we have shown that when an assay is optimized for reagents, conditions, and the volume reduced, a further 10-100 fold improvement can be expected. Further, we can test the final optimized antibodies for cross-reactivity and interference, and begin to multiplex the beads using dyes of differing colors, thus adding more biomarkers to the same platform test. In this way, the platform can be increased from testing 3-5 biomarkers to easily testing 9-20 or biomarkers simultaneously on the existing the lab card.

For example, the table below shows how an array of only 20 adressable locations (or spots) together with red- and green-labelled detection antibodies can allow the preparation of a standard curve having 5 points (top two rows of 5), and the assay of quadruplex samples for four biomarkers, and two negative controls (bottom two rows) in a sandwich immunoassay. The four capture antibodies are assembled when the array is manufactured. The four labelled detection antibodies can be provided together as dried reagents in e.g., a reagent pad or powder mix in a blister, or as liquid reagents in a reagent blister or provided by the fluidics on the analyzer. Where additional biomarkers are desired to be assayed at the same time, the additional detection antibodies can be provided with the regent mixture, or separate fluidics can be provided so that only a few compatible antibodies are assayed in a given fluidic stream. Thus, the lab card shown in FIGS. 4A-4B can be longitudinally duplicated, having more than one array chamber, each supplied with its own fluidics and reagent chambers.

| | | | | |
|---|---|---|---|---|
| CRP & LDH | CRP & LDH | CRP & LDH | CRP & LDH | CRP & LDH |
| anti-CRP-red | anti-CRP-red | anti-CRP-red | anti-CRP-red | anti-CRP-red |
| anti-LDH-green | anti-LDH-green | anti-LDH-green | anti-LDH-green | anti-LDH-green |
| GAFP & NSE | GAFP & NSE | GAFP & NSE | GAFP & NSE | GAFP & NSE |
| Anti-GADP-red | Anti-GADP-red | Anti-GADP-red | Anti-GADP-red | Anti-GADP-red |
| Anti-NSE-green | Anti-NSE-green | Anti-NSE-green | Anti-NSE-green | Anti-NSE-green |
| Sample | Sample | Sample | Sample | Negative control |
| Anti-GADP-red | Anti-GADP-red | Anti-GADP-red | Anti-GADP-red | |
| Anti-NSE-green | Anti-NSE-green | Anti-NSE-green | Anti-NSE-green | |
| Sample | Sample | Sample | Sample | Negative control |
| Anti-CRP-red | Anti-CRP-red | Anti-CRP-red | Anti-CRP-red | |
| Anti-LDH-green | Anti-LDH-green | Anti-LDH-green | Anti-LDH-green | |

Thus, we expect that these preliminary proof of concept data will likewise improve, giving us a range of 4-5 orders of magnitude and ng/ml or pg/ml sensitivity levels and further reductions on inter and intra assay % CV. Further, with extensive marker validation, which may take a few years to perform, we expect that a four biomarker panel of the sensitivity and reliability shown herein will prove an invaluable early diagnostic tool.

The following references are incorporated by reference in their entirety:

Thornton K., Head trauma Rehabil 2000, 15.

Bandyopadhyay, S., et al., Acad Emerg Med 2005, 12, 732-738.

Burgess, J. A., et al., J Proteome Res 2006, 5, 1674-1681.

Christodoulides, Ann. N.Y. Acad. Sciences 1098:411-428 (2007).

Christodoulides et al., Lab. Chip, 5(3):261-9, 2005.

Dash, P. K., et al., 2010. Biomarkers for the Diagnosis, Prognosis, and Evaluation of Treatment Efficacy for Traumatic Brain Injury. Neurotherapeutics 7(1), 100-114.

Denslow, N., et al., J Neurotrauma 2003, 20, 401-407.

Folkerts, M. M., et al., J Neurotrauma 1998, 15, 349-363.

Goodey et al., J. Amer. Chem. Soc., 123(11):2559-2570, 2001.

Haskins, W. E., Kobeissy, F. H., Wolper, R. A., Ottens, A. K., et al., J Neurotrauma 2005, 22, 629-644.

Ingebrigtsen, T., Romner, B., Restor Neurol Neurosci 2003, 21, 171-176.

Kobeissy, F. H., et al., Mol Cell Proteomics 2006, 5, 1887-1898.

Langlois, J. A., et al., Traumatic brain injury in the United States: Emergency department visits, hospitalizations, and deaths. National Center for Injury Prevention and Control, Centers for Disease Control and Prevention, 2004.

Pelsers, M. M., et al., Clin Chim Acta 2005, 352, 15-35.

Pike, B. R., et al., J Cereb Blood Flow Metab 2004, 24, 98-106.

Pike, B. R., et al., J Neurochem 2001, 78, 1297-1306.

Pike, B. R., et al., J Neurotrauma 2000, 17, 283-298.

Pike, B. R., et al., Neuroreport 1998, 9, 2437-2442.

Pineda, J. A., et al., Brain Pathol 2004, 14, 202-209.

Pineda, J., et al., J. Neurotrauma 2007, 24, 354 -366.

Ringger, N. C., et al., J Neurotrauma 2004, 21, 1443-1456.

Romeo, M. J., et al., Expert Rev. Proteomics 2005, 2, 57-70.

Rothman, M. S., et al., J Neuropsych Clin Neurosc 2007, 19, 363-372.

Siman, R., et al., Neurobiol Dis 2004, 16, 311-320.

Smith, D. H., Uryu, K., Saatman, K. E., Trojanowski, J. Q., McIntosh, T. K., Neuromolecular Med 2003, 4, 59-72.

Szekeres-Bartho, J., et al., Acta Neurochir (Wien) 2005, 147, 855-861.

Zemlan, F. P., et al., J. Neurochem 1999. 72, 741-750.

Zhang, L., et al., 2009. A strategy for the development of biomarker tests for PTSD. Medical Hypotheses 73(3), 404-409.

What is claimed is:

1. A lab cartridge for the diagnosis of brain injury, said cartridge comprising an planar substrate having an array of capture reagents for capturing four or more markers selected from the group consisting of: 3-methoxy-4-hydroxyphenylglycol (MHPG), 4-hydroxynonenal, Alpha II Spectrin Breakdown Products (SBDPs), Allopregnanolone, Catecholamines, C-Reactive Protein (CRP), Cortisol, Dehydroepiandrosterone (DHEA), Dehydroepiandrosterone-sulfate (DHEA-S), F2-isoprostane, Fatty acid binding proteins (FABPs), GABA, Glial fibrillary acid protein (GFAP), Interleukin-1 (IL1), Lactate dehydrogenase (LDH), Macrophage inflammatory protein (MIP), Microtubule-associated protein 2 (MAP-2), Monocyte chemo-attractant protein-1 (MCP-1), Myelin basic protein (MBP), N-acetylaspartate (NAA), Neopterin, Neuron specific enolase (NSE), Norepinephrine (NE), Neuropeptide Y (NPY), IL6, S-100b, Amyloid A, IL8, IL2, TAU proteins, Testosterone, Thyroid hormone, Transforming growth factor-beta (TGF-β), Tumor necrosis factor (TNF-alpha), Ubiquitin C-terminal hydrolase (UCH-L1), and Dopamine.

2. The lab cartridge of claim 1, wherein said capture reagents are antibodies.

3. The lab cartridge of claim 1, wherein said capture reagents are monoclonal antibodies.

4. The lab cartridge of claim 1, wherein said capture reagents are antibodies bound to agarose beads or pads.

5. The lab cartridge of claim 1, wherein said capture reagents are monoclonal antibodies bound to agarose beads or pads.

6. The lab cartridge of claim 1, wherein said capture reagents are antibodies bound to a glass substrate.

7. The lab cartridge of claim 1, wherein said capture reagents are antibodies bound to a coated glass substrate.

8. The lab cartridge of claim 1, further comprising microfluidics for fluid flow passed said array of capture reagents.

9. The lab cartridge of claim 4, further comprising a blister pack containing wash buffer upstream of said array of capture reagents.

10. The lab cartridge of claim 4, further comprising a blister pack containing labeled detection antibody upstream of said array of capture reagents.

11. The lab cartridge of claim 4, further comprising a reagent pad containing dried labeled detection antibody upstream of said array of capture reagents.

12. The lab cartridge of claim 1, said array of capture reagents for capturing at least 6 of said markers.

13. The lab cartridge of claim 1, said array of capture reagents for capturing at least 8 of said markers.

14. The lab cartridge of claim 1, said array of capture reagents for capturing at least 10 of said markers.

15. The lab cartridge of claim 1, said array of capture reagents for capturing at least 12 of said markers.

16. A lab cartridge for the diagnosis of brain injury, said cartridge comprising an planar substrate having an array of antibodies on agarose beads for capturing 4, 5, 6, 7, 8, 9, 10, 12, 15, or more markers selected from the group consisting of MHPG, 4-hydroxynonenal, SBDPs, Catecholamines, CRP, Cortisol, DHEA, DHEA-S, F2-isoprostane, FABP, GABA, GFAP, IL1, LDH, MIP, MAP-2, MCP-1, MBP, NAA, Neopterin, NSE, NE, NPY, IL6, S-100b, Amyloid A, IL8, IL2, TAU proteins, Testosterone, Thyroid hormone, TGF-β, TNF-alpha, UCH-L1, and Dopamine.

17. The lab cartridge of claim 16, further comprising one or more blister packs containing reagents upstream of said array and a fluid outlet or waste chamber downstream of said array, said blister packs and said array and said fluid outlet or waste chamber being fluidly connected via embedded channels.

18. An assay for the diagnosis of brain injury, said assay comprising:
a) obtaining a sample of biological fluid from a patient,
b) immunologically testing said sample to determine the level of at least four biomarkers selected from the group consisting of MHPG, 4-hydroxynonenal, SBDPs, Catecholamines, CRP, Cortisol, DHEA, DHEA-S, F2-isoprostane, FABP, GABA, GFAP, IL1, LDH, MIP, MAP-2, MCP-1, MBP, NAA, Neopterin, NSE, NE, NPY, IL6, S-100b, Amyloid A, IL8, IL2, TAU proteins, Testosterone, Thyroid hormone, TGF-β, TNF-alpha, UCH-L1, and Dopamine,
c) wherein an increased level of biomarkers indicates the presence of brain damage, and a decreased level of biomarkers indicates the absence of brain damage.

19. The assay of claim 18,
a) wherein said test is conducted on an array of agarose beads conjugated to antibodies for said biomarkers, and where signal from said array of agarose beads is analyzed by circular area of interest or line profile or both.

20. A disposable brain injury testing cartridge comprising a generally flat substrate having thereon individual bead sensors arranged in an array, wherein each bead sensor is a porous polymeric bead having a capture antibody bound thereto, wherein said capture antibody can bind a biomarker selected from four or more of MHPG, 4-hydroxynonenal, SBDPs, Catecholamines, CRP, Cortisol, DHEA, DHEA-S, F2-isoprostane, FABP, GABA, GFAP, IL1, LDH, MIP, MAP-2, MCP-1, MBP, NAA, Neopterin, NSE, NE, NPY, IL6, S-100b, Amyloid A, IL8, IL2, TAU proteins, Testosterone, Thyroid hormone, TGF-β, TNF-alpha, UCH-L1, and Dopamine.

21. The disposable brain injury testing cartridge of claim 20, further comprising embedded microfluidics in said substrate for carrying fluid to and from said bead sensors.

22. The disposable brain injury testing cartridge of claim 21, further comprising a sample entry port upstream of said array.

23. The disposable brain injury testing cartridge of claim 22, further comprising at least one reagent blister fluidly connected and upstream of said array.

24. The disposable brain injury testing cartridge of claim 23, further comprising at least one waste fluid chamber fluidly connected to and downstream of said array.

25. The disposable brain injury testing cartridge of claim 20, further comprising positive and negative control bead sensors and calibrator bead sensors in said array.

26. The disposable brain injury testing cartridge of claim 20, wherein every bead sensor is present in said array in at least duplicate.

27. The disposable brain injury testing cartridge of claim 20, wherein every bead sensor is present in said array in at least triplicate.

28. The disposable brain injury testing cartridge of claim 20, wherein said biomarker is conjugated to said bead sensor via a linker.

29. The disposable brain injury testing cartridge of claim 20, wherein said bead sensor in stored in at least 25% glycerol.

30. The disposable brain injury testing cartridge of claim 20, wherein said bead sensor in stored in at least 30% glycerol.

31. A disposable brain injury testing cartridge comprising:
a) a generally flat substrate having embedded microfluidic channels connecting a fluid inlet to an embedded downstream assay chamber containing as array of bead sensors and having a transparent cover over said assay chamber,
b) one or more reagent chambers fluidly connected to and upstream of said assay chamber; and
c) one or more waste fluid chambers fluidly connected to and downstream of said assay chamber;
d) wherein each bead sensor is a porous polymeric bead of size between 50-300 nm, and the bead size variation is ±10%, and each bead having at least one antibody conjugated thereto, wherein said antibody binds a biomarker selected from four or more of MHPG, 4-hydroxynonenal, SBDPs, Catecholamines, CRP, Cortisol, DHEA, DHEA-S, F2-isoprostane, FABP, GABA, GFAP, IL1, LDH, MIP, MAP-2, MCP-1, MBP, NAA, Neopterin, NSE, NE, NPY, IL6, S-100b, Amyloid A, IL8, IL2, TAU proteins, Testosterone, Thyroid hormone, TGF-β, TNF-alpha, UCH-L1, and Dopamine.

32. The disposable brain injury testing cartridge of claim 31, wherein said bead sensor comprises crosslinked agarose.

33. The disposable brain injury testing cartridge of claim 31, wherein said bead sensor is conjugated to said antibody via a linker.

34. The disposable brain injury testing cartridge of claim 31, wherein said bead sensor is conjugated to said antibody via a peptide linker

35. The disposable brain injury testing cartridge of claim 31, wherein one of said reagent chambers contains an absorbent pad containing dried detection antibodies for said biomarkers, each detection antibody conjugated to a fluorophore.

36. The disposable brain injury testing cartridge of claim 35, wherein at least one of said reagent chambers contains a wash buffer.

37. A lab-on-chip system for drug testing comprising:
a) a housing containing i) a loading deck for receiving a cartridge, ii) a processor having a user interface, iii) an optical or energy sensing means, and iv) a means for moving fluid;
b) a cartridge comprising a substrate having inlets and microfluidics for moving fluid and a plurality of individual bead sensors in an array, wherein each bead sensor is a porous polymeric bead having at least one antibody bound thereto, wherein said antibody binds to a biomarker selected from four or more of MHPG, 4-hydroxynonenal, SBDPs, Catecholamines, CRP, Cortisol, DHEA, DHEA-S, F2-isoprostane, FABP, GABA, GFAP, IL1 LDH, MIP, MAP-2, MCP-1, MBP, NAA, Neopterin, NSE, NE, NPY, IL6, S-100b, Amyloid A, IL8, IL2, TAU proteins, Testosterone, Thyroid hormone, TGF-β, TNF-alpha, UCH-L1, and Dopamine;
c) wherein said cartridge fits into said loading deck such that said inlets are fluidly connected to said means for moving fluid;
d) wherein said optical sensing means is configured to receive a signal from said bead sensors;
e) wherein said microfluidics are configured to allow fluid movement past said bead sensors; and
f) wherein said processor and user interface control said lab-on-chip system and said processor records data from said optical sensing means.

38. The system of claim 37, wherein said processor uses line profile and/or circular area of interest to analyze said data.

39. A brain injury testing assay comprising:
a) a microfluidic lab-on-chip based immunoassay that uses a disposable cartridge and a separate reader, wherein said cartridge fits into a slot on said reader, and said reader performs said immunoassay and outputs a result,
b) said cartridge comprising:
i) a generally flat substrate having embedded microfluidic channels connecting an inlet port to an embedded downstream assay chamber having a transparent cover and containing a removable array of bead sensors,
ii) one or more reagent chambers fluidly connected to and upstream of said assay chamber; and
iii) one or more waste fluid chambers fluidly connected to and downstream of said assay chamber;
c) wherein each bead sensor is a porous polymeric bead of size between 50-300 nm, with a size variation of ±10% and having at least one antibody conjugated thereto, wherein each said antibody binds a biomarker selected from four or more of MHPG, 4-hydroxynonenal, SBDPs, Catecholamines, CRP, Cortisol, DHEA, DHEA-S, F2-isoprostane, FABP, GABA, GFAP, IL1, LDH, MIP, MAP-2, MCP-1, MBP, NAA, Neopterin, NSE, NE, NPY, IL6, S-100b, Amyloid A, IL8, IL2, TAU proteins, Testosterone, Thyroid hormone, TGF-β, TNF-alpha, UCH-L1, and Dopamine;
d) wherein said immunoassay has a lower limit of detection for each of said biomarkers of <10 ng/ml and a detection range of at least three orders of magnitude.

40. The brain injury testing assay of claim 39, wherein at least some of said bead sensors are multiplexed and have two antibodies that bind two of said biomarkers.

41. The brain injury testing assay of claim 39, said cartridge comprising antibodies for each of said biomarkers.

42. A lab cartridge for the diagnosis of brain injury, said cartridge comprising:
a) a generally planar substrate having embedded microfluidic channels connecting an inlet port to an embedded downstream assay chamber having a transparent cover and containing an array of antibodies,
i) said array of antibodies for capturing at least 4 brain injury biomarkers selected from the group consisting of MHPG, 4-hydroxynonenal, SBDPs, Catecholamines, CRP, Cortisol, DHEA, DHEA-S, F2-isoprostane, FABP, GABA, GFAP, IL1, LDH, MIP, MAP-2, MCP-1, MBP, NAA, Neopterin, NSE, NE, NPY, IL6, S-100b, Amyloid A, IL8, IL2, TAU proteins, Testosterone, Thyroid hormone, TGF-β, TNF-alpha, UCH-L1, and Dopamine;
b) a plurality of reagent chambers fluidly connected to and upstream of said assay chamber,
i) at least one of said reagent chambers containing labeled detection antibodies for detecting the at least 4 brain injury biomarkers from a),
ii) at least one of said reagent chambers containing wash buffer; and
c) one or more waste fluid chambers fluidly connected to and downstream of said assay chamber.
